(19) United States
(12) Patent Application Publication
(10) Pub. No.: US 2010/0041535 A1
(43) Pub. Date: Feb. 18, 2010

(54) SOLID-BOWL SCREW CENTRIFUGE AND PROCESS FOR ITS OPERATION

(75) Inventors: Ulrich Horbach, Hamm (DE); Tore Hartmann, Oelde (DE); Knud Schöneberg, Stade (DE)

Correspondence Address: BARNES & THORNBURG LLP, 750-17TH STREET NW, SUITE 900, WASHINGTON, DC, 20006-4675, US

(73) Assignee: WESTFALIA SEPARATOR AG, 59302 Oelde (DE)

(21) Appl. No.: 12/278,942

(22) PCT Filed: Feb. 7, 2007
(86) PCT No.: PCT/EP07/51175

§ 371 Date: Oct. 7, 2009

(30) Foreign Application Priority Data
Feb. 10, 2006 (DE) 10 2006 006 178.0

(51) Int. Cl. B04B 7/08; B04B 1/20; B04B 13/00

(52) U.S. Cl. 494/5; 494/53; 494/37

(57) ABSTRACT

A solid-bowl screw centrifuge includes a rotatable drum having a horizontal axis of rotation, which drum surrounds a centrifuging space. Further included is a screw which is arranged within the drum, the screw being rotatable at a different speed relative to the drum. Further included is at least one liquid discharge sealed from its surroundings and at least one solid discharge in a tapering region of the drum. Also included is an immersion disk on the screw which disk lies between a liquid feed and the solid discharge and divides the centrifuging space into a discharge space between the immersion disk and the solid discharge, and a separation space between the immersion disk and the liquid discharge. The centrifuge includes a device for charging the separation space with a gas. A process for operating for the solid-bowl centrifuge is also disclosed.

The invention relates to a solid-bowl screw centrifuge according to the precharacterizing clause of claim 1 and to a process for its operation.

A solid-bowl screw centrifuge—also known as a decanter—is provided with a rotatable drum, which has a cylindrical and tapering, generally conical, portion. Arranged in the drum is a screw, which during operation rotates at a differential speed in relation to the drum.

In the decanter drum, an added suspension is separated into a liquid phase and a solid phase as a result of the centrifugal effect. At the same time, the solid material moves outward toward the inner wall of the drum, where it forms an annular layer. The differential motion between the drum and the screw causes conveyance of the solid material, which is purely axial in the cylindrical part of the drum. In the conical part of the drum, radial conveyance is also required, counter to the centrifugal force acting.

Such a structural design is shown for example by DE 43 20 265 A1. In the case of the design shown in this document, the distance between a weir for liquid discharge and a throttling disk can be changed by turning a threaded bush. The accompanying changing of the outflow cross section brings about a change in the liquid level in the centrifuging drum, so that infinitely variable setting of this liquid level is possible by displacing the throttling disk.

It is known from DE 198 30 653 C1 to realize the liquid discharge of an open solid-bowl screw centrifuge by means of a peeling disk, downstream of which there is a labyrinth seal to return product droplets to the peeling disk. According to this design, there is no need for sealing from the space outside.

A solid-bowl screw centrifuge in which the product space is sealed from the outside is disclosed by DE 102 23 802 B4. A barrier chamber with a barrier fluid feed in combination with an immersion disk and a siphon disk make it possible in this design for the centrifuging chamber to be sealed from the surrounding atmosphere. Although the design itself has proven successful, it is only conditionally suitable for the processing of products in which the solid material to be discharged or the phase to be discharged at the conical end is of relatively low viscosity.

DE 40 33 012 A1 and DE 30 22 148 A1 are also cited as prior art.

It is also known in the case of some types of decanter to measure the torque between the screw and the drum that is necessary for conveyance and to use this as an indicator of the amount of solid material located in the drum. If the decanter is appropriately equipped (two-gear drive or comparable), it is possible to regulate the differential speed in dependence on the measured torque in such a way that a largely constant degree of filling with solid material in the decanter can be set.

The mechanical conveyance by the screw is based substantially on force transmission by internal friction. The extent to which mechanical conveyance is possible therefore depends on the rheological properties of the solid-material composition.

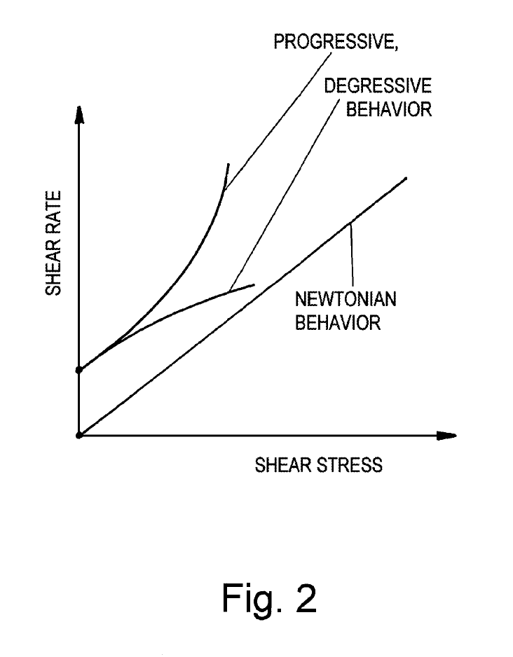

FIG. 2 schematically illustrates the shearing motion in the solid material in dependence on an applied shear stress. One of the curves describes purely Newtonian behavior, in which there is a constant ratio between shear stress and shear rate (viscosity) over the entire range under consideration. As a departure from this, the other curve shown comprises, for example, a primary shear stress, which first has to be exceeded before a shearing motion occurs. The greater the viscosity of a material, the better it can be mechanically conveyed. Conversely, difficulties occur in the discharge of solid material if the phase to be discharged is of a particularly low viscosity.

If the solid material has a low viscosity, under some circumstances it is possible to compensate for this by a correspondingly high differential speed. However, this method leads to different disadvantages, which often make it difficult for a decanter to be used for such separating tasks. Examples of these are
extraction of pectins
extraction of lysine
thickening of surplus pulp
beer recovery from spent yeast.

The invention is particularly suitable for the processing of these products.

Operational experience has shown that in these applications it is scarcely possible in mechanical terms to achieve in particular the radial conveyance in the cone counter to the centrifugal effect.

To solve the problem of discharging relatively low-viscosity solid phases, it has been proposed in U.S. Pat. No. 5,244,451 to blow compressed air into the solid phase in the region of the cone, in order to reduce the average density of the solid phase. This has the effect that the solid material is forced inward and in the direction of the solid-material discharge openings at the conical end of the drum. Disadvantageous from aspects of structural design and process engineering are, in particular, the high pressures to be applied, which are 10 to 15 bar.

It is proposed in the generic document U.S. Pat. No. 3,885,734 to admit gas directly to the separation space. However, a disadvantage of this is that, although it may be possible after the pressurization for solid materials to be discharged, it is not possible to achieve a constantly improved discharge of solid material in stationary operation.

Against this background, the object of the invention is to provide a solid-bowl screw centrifuge and a process for operating the solid-bowl screw centrifuge that also make it possible for relatively low-viscosity solids to be discharged.

The invention achieves this object by the subject matter of claim 1. The invention also provides a simple process for operating the centrifuge according to the invention. This is specified in claim 14.

If a pressure other than ambient pressure is imposed on the separation space, i.e. the space in which the separation or decantation takes place, an inside diameter of the solid material that is dependent on the difference in pressure will be established in the conical discharge space, since the liquid discharge is hermetically sealed from the ambient pressure in such a way that—in interaction with the baffle—the inside diameter of the pond in the region of the separation space remains unchanged when there is an increase in pressure in stationary operation. This is not the case in the generic document U.S. Pat. No. 3,885,734, since here the separation space is in connection with the ambient pressure at the liquid discharge in the manner of communicating tubes, so that when there is an increase in pressure there is a shift in the liquid level in the separation space, which has the consequence that the discharge of solid material is not permanently improved during operation. In the case of the invention, on the other hand, the sealing of the liquid discharge takes place by means of a peeling disk or by some other sealing means—for example a hydrohermetic chamber, which is designed such that the pressurization does not lead to a shift in the level in the separation space.

If this inside diameter is less than the diameter of the solid-material discharge of the drum, low-viscosity solid material is also conveyed out of the drum. If it is greater, there is no solid-material discharge. In order to carry such solid material away, it is generally merely necessary to apply a pressure of 0 to 10 bar, in particular 0.5 bar or more, in particular 0.5 to 5 bar, to the separation space.

Preferably, the device for admitting a gas to the separation space has a feed line into the separation space, which during operation opens out into the separation space on a radius that is less than the radius of the liquid level during operation.

The gas may be compressed air (in particular also sterile air) or for example nitrogen.

The invention is advantageously supplemented by optical measurement of the torque between the drum and the screw, which is a measure of the degree of filling with solid material in the decanter. The signal is fed to the pressure control unit and evaluated and used as a control signal for a setpoint value of the imposed pressure. The differential speed between the screw and the drum thereby remains constant. It is consequently possible to dispense with a secondary drive for changing the differential speed. Rather, this remains constant. The actual control of the process on the other hand takes place in a simple way by variation of the pressure in the separation space. With particular preference, the pressure on the separation space is measured by means of a further line.

In a development or variation of the invention, the amount of solid-material discharge is controlled or regulated in a simple way by means of variation of the pressure in the separation space.

Particular advantages of the invention in its variants are consequently:
Monitored metering of the conveyance of solid material in the decanter even in the case of solid-material compositions which, in mechanical terms, cannot be conveyed, or only with difficulty.
A possible cost saving obtained by dispensing with the secondary drive.
No influence on the conveyance of solid material by the so-called idling torque, which is dependent on the high differential speed. Rather, it is preferably possible for the differential speed, consequently also the idling torque, to be kept constant.
Solid material can be drawn off over a small diameter.

The admission of a gas to the separation space offers a simple and optional possible way of imposing a protective gas on the sedimentation pond.

Further advantageous refinements of the invention are specified in the remaining subclaims.

The invention is explained in more detail below on the basis of an exemplary embodiment with reference to the drawing, in which:

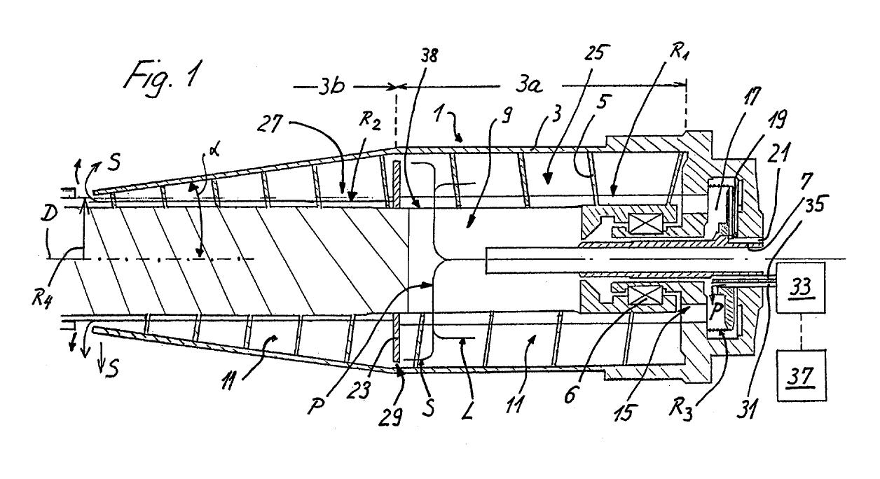

FIG. 1 shows a section through a schematically represented solid-bowl screw centrifuge according to the invention; and

FIG. 2 shows a diagram to illustrate the shearing behavior of solid-material compositions.

FIG. 1 shows a solid-bowl screw centrifuge 1 with a drum 3 with a horizontal axis of rotation D, in which a screw 5 is arranged. The drum 3 and, under some circumstances, also the screw have a substantially cylindrical portion 3a and a tapering portion 3b, here tapering conically.

An axially extending central inlet tube 7 serves for feeding the material to be centrifuged P into the centrifuging space 11 between the screw 5 and the drum 3 via a distributor 9, which here is perpendicular to the inlet tube 7, the distributor 9 having a liquid feed 38 into the centrifuging space 11.

If, for example, a sludgy slurry is introduced into the drum 3, particles of solid material are deposited on the drum wall. Further toward the inside, there forms a liquid phase.

The screw 5, mounted by the bearing 6, rotates at a somewhat lower or greater speed than the drum 3 and conveys the centrifuged solid material S to the conical portion, to a solid-material discharge 13.

The liquid L on the other hand flows toward the greater drum diameter at the rear end of the cylindrical portion of the drum 3, where it is passed through a weir 15 into a chamber 17, which axially adjoins the actual centrifuging space and arranged in which is a peeling disk 19 for draining away the liquid phase L, which has one or more draining channel (s) 21, through which the liquid phase L is drained out of the drum 3.

The peeling disk 19 may be arranged directly on the inlet tube 7, which is stationary during operation, it being possible for example to realize a sealed gap-free arrangement between the peeling disk 19 and the inlet tube 7.

The liquid discharge is consequently formed in such a way that it is sealed from the ambient pressure.

In the transitional region between the cylindrical portion 3a and the conical portion 3b, the screw 5 preferably has ahead of the solid-material discharge 13 an immersion disk 23, which extends from the screw 5 radially outward into the centrifuging space 11 and is immersed in the liquid level R1.

The immersion disk 23 is expediently fitted axially to the end on the solid-material side of the cylindrical portion of the drum. It divides the overall drum space into a separation space 35 between the liquid discharge (peeling disk 19) and the immersion disk 11 and a discharge space 27 between the solid-material discharge 13 and the immersion disk 11.

The immersion disk 23 may also be fitted in the conical portion. It is essential that it is arranged between the solid-material discharge 13 and the liquid feed 38.

Moreover, its diameter or radius is intended to be greater than the radius R4, up to which the solid-material discharge 13 extends as a maximum.

The outer contour of the immersion disk 23 forms with the inner wall of the drum an annular gap, the so-called immersion disk gap 29, through which the solid material passes from the separation space 25 to the solid-material discharge 13. The end on the liquid side of the separation space 25 is sealed from the surroundings, which can be realized for example by the internal peeling disk 19 with a drainage diameter R3 or hydrohermetics (not represented here), in order to prevent a free exchange of gas between the separation space 25 and the surroundings. The combination of the immersion disk 23 and the sealed liquid discharge 19 has the effect that the separation space 25 in which the separation takes place is thereby hermetically sealed from the surroundings or the surrounding atmosphere.

The device for admitting a gas to the separation space 25 has a feed line 21 leading into the centrifuge from the outside—here for example a bore parallel to the inlet tube 7 on the outer circumference of the latter, which makes it possible for a gas to be fed into the separation space 25, for example from a pressure control unit 33. A further line 35 makes it possible to measure the pressure D in the separation space 25 by means of a suitable measuring device, which may be integrated in the pressure control unit 33. The pressure control unit 33 is in turn connected to a controlling or regulating device 37 for controlling or regulating the decanter.

The feed line 31 makes it possible in the simplest way for the pressure in the separation space 25 of the drum to be varied.

The system in operation is schematically represented in FIG. 1. In the separation space 25 there forms an annular suspension pond. The liquid discharge is thereby hermetically sealed from the ambient pressure in such a way that the inside diameter R1 of the pond in the region of the separation space 25 remains unchanged when there is an increase in pressure. It corresponds substantially to the regulating diameter. On the other hand, ambient pressure prevails in the conical discharge space 27.

If a pressure other than ambient pressure is then applied to the separation space 25 via the line 31, an inside diameter R2 of the solid phase that is dependent on the difference in pressure will be established in the conical discharge space 27. If this inside diameter R2 is less than the solid-material discharge diameter R4 (that is to say the diameter over which the solid-material discharge openings lie), a solid-material discharge takes place even of a very low-viscosity liquid phase.

The conicity angle α between the longitudinal axis (or approximately the axis of rotation D) of the drum and the conical portion 3b is preferably 10° to 90°, preferably more than 15°, in particular more than 30°. In the case of the solution according to the invention, with a conical design, a relatively great conicity angle is therefore advantageous or possible, which has the advantage that the drum is very short in the axial sense. In the limiting case of 90°, the drum with a conical portion becomes an entirely cylindrical drum, which is to be subsumed here as a limiting case under the wording of the claims.

### LIST OF DESIGNATIONS

solid-bowl screw centrifuge 1
bearing 2
drum 3
cylindrical portion 3a
tapering portion 3b
screw 5
inlet tube 7
distributor 9
centrifuging space 11
solid-material discharge 13
weir 15
chamber 17
peeling disk 19
drainage channel 21
immersion disk 23
separation space 25
discharge space 27
immersion disk gap 29
feed line 31
pressure control unit 33
measuring line 35
measuring device 37
liquid feed 38
liquid levels R1, R2, R3, R4
material to be centrifuged P
liquid phase L
solid phase S
axis of rotation D
pressure P

We claim:

1. A solid-bowl screw centrifuge comprising:
a rotatable drum having a horizontal axis of rotation, the rotatable drum surrounding a centrifuging spacer and including at least a tapering portion;
a screw is arranged in the drum, the screw being rotatable at a differential speed in relation to the drum;
at least one solid-material discharge located in the tapering portion of the drum;
an immersion disk on the screw, which disk lies between a liquid feed and the solid-material discharge and subdivides the centrifuging space into a discharge space located between the immersion disk and the solid-material discharge and a separating space located between the immersion disk and a liquid discharge;
a device for admitting a gas to the separation space; and
wherein
the liquid discharge is sealed from its surroundings in such a way that level R1 of a pond in a region of the separation space remains unchanged when pressurization occurs.

2. The solid-bowl screw centrifuge as claimed in claim 1, wherein the device for admitting a gas to the separation space includes a feed line into the separation space, which feed line, during operation, opens out into the separation space on a radius that is less than the radius of the liquid level R1.

3. The solid-bowl screw centrifuge as claimed in claim 1, wherein the device for admitting a gas to the separation space includes a pressure control device which is connected to a feed line into the separation space.

4. The solid-bowl screw centrifuge as claimed in claim 1, wherein the device for admitting a gas to the separation space is assigned to a measuring device, which measuring device measures the pressure in the separation space by a bore into the separation space.

5. (canceled)

6. The solid-bowl screw centrifuge as claimed in claim 1, the drum further including a cylindrical portion and wherein the immersion disk is arranged on the screw in a transitional region between the tapering portion and the cylindrical portion of the drum.

7. The solid-bowl screw centrifuge as claimed in claim 1, wherein the immersion disk has a radius which is greater than a radius, R4 up to which the solid-material discharge extends as a maximum.

8. The solid-bowl screw centrifuge as claimed in claim 1, wherein an end on a liquid side of the separation space is sealed from its surroundings.

9. The solid-bowl screw centrifuge as claimed in claim 1, wherein the liquid discharge includes and takes place by at least one peeling disk.

10. The solid-bowl screw centrifuge as claimed in claim 1, further comprising a hydrohermetic chamber is arranged upstream of the liquid discharge.

11. The solid-bowl screw centrifuge as claimed in claim 1, wherein the tapering portion is conically formed portion.

12. The solid-bowl screw centrifuge as claimed in claim 11, wherein a conicity angle α between the horizontal axis of the drum and the conical portion is 10° to 90°.

13. The solid-bowl screw centrifuge as claimed in claim 11, wherein ambient pressure prevails in the discharge space.

14. A process for operating a solid-bowl centrifuge, the process steps comprising:
providing a solid-bowl centrifuge that includes
a rotatable drum having a horizontal axis of rotation, the rotatable drum surrounding a centrifugal space and having a tapering portion,
a screw arranged in the drum and rotatable at a differential speed in relation to the drum,
at least one liquid discharge which is sealed from its surroundings,
at least one solid-material discharge located in the tapering portion of the drum,
an immersion disk on the screw, which disk lies between a liquid feed and the at least one solid-material discharge, the immersion disk subdividing the centrifuging space into a discharge space between the immersion disk and the at least one solid-material discharge and a separating space between the immersion disk and the at least one liquid discharge, and
a device to admit gas to the separation space;
feeding a material to be centrifuged into the centrifuge via an inlet tube;
operating the centrifuge;
applying pressure to the separation space via a feed line wherein a level of a pond in a region of the separation space remains unchanged.

15. The process as claimed in claim 14, wherein the applied pressure to the separation space via the feed line is an applied pressure that is other than ambient pressure.

16. The process as claimed in claim 14, wherein the applied pressure is between 0 and 10 bar.

17. The process as claimed in claim 14, wherein the applied pressure is between 0.5 and 5 bar.

18. The process as claimed in claim 14, wherein the applied pressure to the separation space is measured via a bore.

19. The process as claimed in claim 14, wherein the applied pressure in the separation space is set in such a way that a level R2 of a solid phase in the discharge space is less than a solid-material discharge level R4, at which level R4 the solid-material discharge of the drum lies.

20. The process as claimed in claim 14, further comprising the process steps of keeping constant a differential speed between the screw and the drum and providing a pressure control unit, to measure a torque between the drum and the screw, which torque is used as a measure of a degree of filling of solid material in the drum, wherein the measurement of the pressure control unit is evaluated and used as a control signal for a setpoint value of the applied pressure.

21. The process as claimed in claim 14, wherein an amount of discharged solid-material is controlled by a variation of the applied pressure in the separation space.

22. The solid-bowl screw centrifuge of claim 11, wherein a conicity angle α between the horizontal axis of the drum and the conical portion is more than 15°.

23. The solid-bowl screw centrifuge of claim 11, wherein a conicity angle α between the horizontal axis of the drum and the conical portion is more than 30°.
